(19) United States
(12) Patent Application Publication
(10) Pub. No.: US 2007/0003276 A1
(43) Pub. Date: Jan. 4, 2007

(54) Dual-lens assembly and image photographing apparatus having the same

(75) Inventor: Jeong-goo Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/358,153

(22) Filed: Feb. 22, 2006

(30) Foreign Application Priority Data
Jul. 1, 2005 (KR) 2005-0059218

(51) Int. Cl. G03B 19/00

(52) U.S. Cl. 396/429

(57) ABSTRACT

A dual-lens assembly for an image photographing apparatus includes a board that performs a predetermined function in an image photographing apparatus. A first lens unit is joined with the board, and a second lens unit is joined with the board. The first and second lens units are oriented so that they obtain images in the same direction.

### CROSS-REFERENCE TO RELATED APPLICATIONS

This application claims the benefit under 35 U.S.C. § 119(a) of Korean Patent Application No. 2005-59218, filed on Jul. 1, 2005, the entire contents of which are hereby incorporated by reference.

### BACKGROUND OF THE INVENTION

1. Field of the Invention

The present invention relates to a dual-lens assembly having two independent lens modules for photographing moving images and still images, and an image photographing apparatus having the same.

2. Description of the Related Art

In general, a DSC (Digital Still Camera) converts an image that enters through a lens into a digital signal, and stores it in a recording medium such as a hard disk or a memory card. The photographed image is then stored in the recording medium, not on photographic film, and can be entered directly to a computer. Since a digital still camera is fully compatible with a computer, anyone with a personal computer can easily edit and modify a digital image (that is, a photograph). Also, the photographed image may be transmitted to an external computer system. However, due to the limited capacity of the recording medium, digital still cameras are mainly used for photographing still images. Although some digital still cameras are capable of recording moving images, their recording time is insufficient. Normally, recording moving (or video) images requires two separate processes: one for recording video images and another for recording and reproducing audio for the video images. Therefore, realistically, a digital still camera is inadequate for recording and reproducing video images with sound. For this reason, people prefer a camcorder, which is capable of recording or reproducing both video images of a subject being photographed and audio onto or from a recording medium such as a tape.

Typically, a camcorder uses a cassette tape as its recording medium. The cassette tape is mounted in a deck for video recording. Also, a camcorder is typically provided with a microphone and a speaker. The camcorder, like the digital still camera, is capable of photographing a still image, but its picture quality is typically not as good as that of a digital still camera. Thus, the camcorder is used mostly for recording video images. Because a camcorder has more functions and thus a more complicated construction than a digital still camera, a typical camcorder is larger and more expensive than a digital still camera.

Until recently, when people wanted to take advantage of both digital still cameras and camcorders, they had to purchase two separate products. This was a financial burden on users, and was also inconvenient because a user had to carry two separate products. To resolve this problem, there have been efforts to devise an apparatus for photographing a still image and recording a video image, that is, having functions of both a digital still camera and a camcorder built into a single product, so that a user can selectively choose which one to use according to the circumstances. A “dual cam” has been developed and sold as one such product.

A dual cam has two lens modules with a different number of pixels. For instance, a lens module with a relatively higher number of pixels may be used for photographing a still image, whereas a lens module with a relatively lower number of pixels may be used for recording video images. Dual cam image photographing apparatuses capable of storing still images and moving (video) images photographed by each lens module in a medium such as a hard disk or a memory are now being actively developed.

In the dual cam, however, incorporating two products into a single product has caused problems such as an increased product size and a more complicated structure. Therefore, recent research has focused on developing an image photographing apparatus having a simpler structure and a small size. Furthermore, research continues on improving manufacturing productivity.

Accordingly, there is a need for a simpler, more compact image photographing apparatus capable of photographing both still images and moving (video) images.

### SUMMARY OF THE INVENTION

An aspect of the present invention is to address at least the above problems and/or disadvantages and to provide at least the advantages described below. Accordingly, an aspect of the present invention is to provide a dual-lens assembly with an improved structure featuring a simple and easy arrangement of a plurality of lens modules, and an image photographing apparatus having the same.

To achieve the above objects and advantages, a dual-lens assembly comprises a board performing a predetermined function in an image photographing apparatus, a first lens unit joined with the board, and a second lens unit joined with the board. The second lens unit is oriented so that it obtains an image in the same direction as the first lens unit.

The first and second lens units may be arranged so that a virtual reference line connecting an optical axis passing through each of the lens units crosses a plane of the board.

The reference line and the plane of the board may form an angle of about 40° to 50° with respect to one another.

In an exemplary embodiment, the first lens unit may comprise a first lens module for photographing high quality picture images, a lens holder for encompassing the first lens module, and a first support bracket attached to the board for supporting the lens holder and the first lens module.

In an exemplary embodiment, the second lens unit may comprise a second lens module for obtaining moving picture quality images and a second support bracket for supporting the second lens module to the board and the first lens unit.

The second support bracket may comprise a first locking hole through which a screw is inserted into the second lens module, a second locking hole through which a screw is inserted into the lens holder, and a third locking hole through which a screw is inserted into the board.

The first lens unit may be installed at a lower position than the second lens unit.

The first lens unit may be arranged in a manner that the optical axis of the first lens unit is separated from the plane of the board.

The optical axes of the first and second lens units may be separated from each other.

The first and second lens units may be installed on opposite sides of the board and may be vertically offset with respect to one another.

In accordance with another exemplary embodiment of the present invention, an image photographing apparatus comprises a main body, a board performing a predetermined function disposed in the main body, a first lens unit joined with the board, and a second lens unit joined with the board. The second lens unit is oriented so that it obtains an image in the same direction as the first lens unit.

In accordance with still another exemplary embodiment of the present invention, an image photographing apparatus comprises a main body. A board is disposed in the main body, and the board has a plurality of electronic components for processing image data. A first lens unit is mounted on the board and has a first optical axis. The first lens unit obtains image data of a first quality and provides the image data to the plurality of electronic components. A second lens unit is mounted on the board and has a second optical axis. The second lens unit obtains image data of a second quality and provides the image data to the plurality of electronic components. The first and second optical axes are generally aligned so that the first and second lens units obtain images from the same direction.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a schematic front view of an image photographing apparatus according to an exemplary embodiment of the present invention;

FIG. 2 is an exploded perspective view of the dual-lens assembly shown in FIG. 1;

FIG. 3 is a perspective view of the first lens unit of FIG. 2, assembled;

FIG. 4 is a perspective view of the second lens unit of FIG. 2, assembled;

FIG. 5 is a perspective view of the second lens unit joined with a board; and

FIG. 6 is a perspective view of a dual-lens assembly (a first and a second lens unit) joined with a board.

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

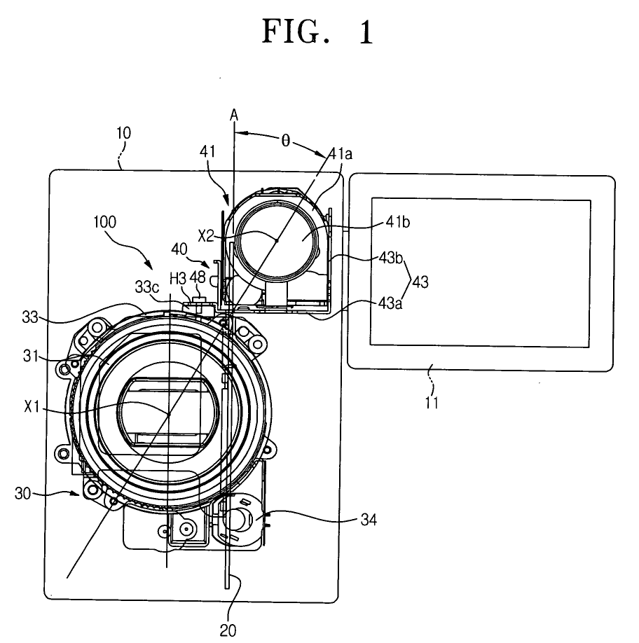

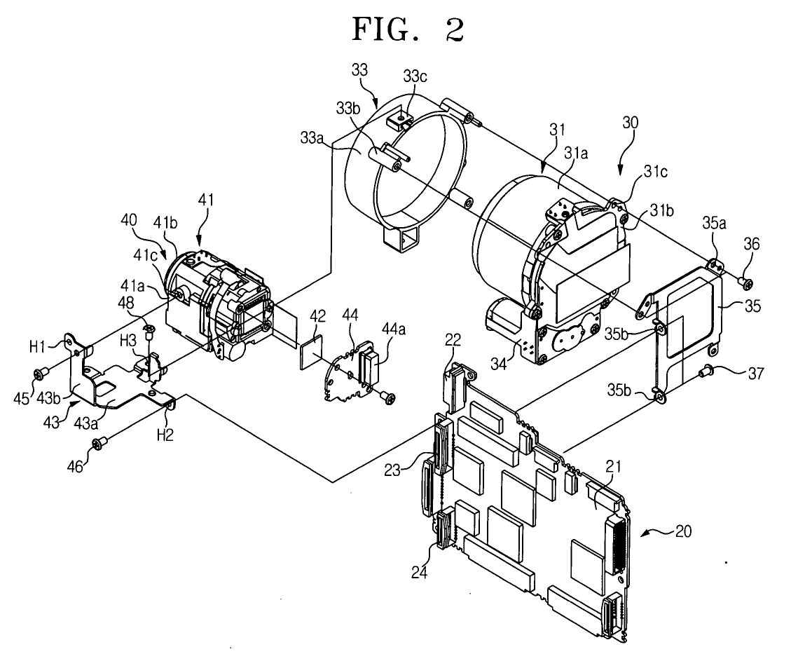

Referring to FIGS. 1 and 2, an image photographing apparatus according to an exemplary embodiment of the present invention includes an image photographing apparatus main body 10, and a dual-lens assembly 100 installed in the main body 10. The dual-lens assembly 100 includes a board 20, and first and second lens units 30, 40 joined with the board 20.

A data storage medium (not shown) is installed in the main body 10. Images (or image data) provided by each lens unit 30, 40 are stored in the storage medium. Also, a display panel 11 for displaying an image that enters through each lens unit 30, 40 is attached in an openable and closable manner to the outside of the main body 10.

The board 20 is electrically connected to both of the first and second lens units 30, 40 and controls the operation of each lens unit 30, 40 and processes photographed image data provided by the lens units 30, 40. The board 20 has a substantially planar shape and is installed in the main body 10 in such a manner that its plane 21 stands basically upright. A plurality of electronic components are installed on the board 20. Connectors 22, 23, 24 are provided on the board 20 and are connected to the first and second lens units 30, 40 and other functional components through a cable.

In an exemplary embodiment, the first lens unit 30 is a digital still camera lens (DSC-lens) which may be used for photographing a still image. In particular, the first lens unit may be used for taking a high picture quality image by employing a CCD having a high number of pixels. The first lens unit 30 includes a first lens module 31, a lens holder 33 for encompassing and supporting the lens module 31, and a first support bracket 35 for attaching the lens holder 33 and the first lens module 31 to the board 20.

The first lens module 31 has a cylindrical shaped housing 31a in which a lens is installed. The lens holder 33 is fit into the outside of the housing 31a from the front side of the first lens module 31. Meanwhile, the rear side of the first lens module 31 is combined to a CCD (Charge-Coupled Device) (not shown) and a CCD board. Moreover, on the rear side of the first lens module 31 there is a coupling part 31b having a locking hole 31c into which a screw is inserted. This coupling part 31b may be combined with the housing 31a as one unit, or screwed into the housing 31a as a separate component. Also, a drive motor 34 for driving the internal lens is installed at the outside of the first lens module 31.

The lens holder 33 has a pipe-shaped body 33a for encompassing the outside of the housing 31a, and a first and a second screw coupling part 33b, 33c combined as one unit on the outside of the body 33a. The first screw locking part 33b is formed to correspond to a locking hole 31c of the coupling part 31b. Therefore, the first support bracket 35 and a screw 36 passing through the locking hole 31c are locked to a first screw coupling part 33b, so that the first lens module 31, the lens holder 33 and the first support bracket 35 may be locked together.

The first support bracket 35 has a plurality of first screw holes 35a formed to correspond to the locking holes 31c for the screws 36. Screws 37 pass through a plurality of second screw holes 35b to lock the first support bracket 35 to the board 20. The portion of the first supporting bracket 35 where the second screw holes 35 are formed is bent so that it is substantially parallel with the board 20. The first support bracket 35 is preferably made of metal.

The first lens unit 30 having the above configuration is arranged so that an optical axis x1 passing through the lens is spaced a distance away from the plane 21 of the board 20. In the illustrated, exemplary embodiment of the present invention, the first lens unit 30 is located on the left side of the board 20 when seen from the front of the body 10 (that is, from the direction of a subject being photographed).

The second lens unit 40 includes a second lens module 41, and a second support bracket 43 for supporting the second lens module 41 to the board 20 and the first lens unit 30.

The second lens module 41 is used mainly for photographing moving images. That is, the second lens module produces images with a smaller number of pixels, yielding a poorer picture quality that that of the first lens module 31. A lens 41b is installed in front of a housing 41a, and another lens (not shown) is installed inside the housing 41a.

A locking boss 41c where a screw 45 is inserted is formed on one side of the housing 41a, and a CCD board 44 for driving a CCD 42 is attached to the rear side of the housing 41a. The CCD board 44 is provided with a connector 44a which joins the connector 22 on the board 20.

The second support bracket 43 has an “L” shape. In detail, it has a horizontal portion 43a and a vertical portion 43b. The top end of the vertical portion 43b has a first locking hole H1 through which a screw 45 is inserted into the locking boss 41c of the second lens module 41. The horizontal portion 43a has a second locking hole H2 through which a screw 46 is inserted into the board 20, and a third locking hole H3 through which a screw 48 is inserted into the second screw coupling part 33c of the lens holder 33. In this manner, the second support bracket 43 combines with the second lens module 41, the lens holder 33 and the board 20, which in turn makes the first and second lens units 30, 40 firmly fastened to the board 20.

The second lens unit 40 having the above configuration is arranged in such a manner that an optical axis x2 passing through the lens is spaced away from the plane 21 of the board 20 as well as the optical axis X1. In detail, the second lens unit 40 is located on the right side of the board 20, on the opposite side of the board 20 than the first lens unit 30. The second lens unit 40 is located above the first lens unit 30. More specifically, the lens units 30, 40 are arranged so that a virtual reference line L1 connecting the two axes X1 and X2 cross the plane 21 of the board 20, that is, a reference plane A parallel to the plane 21 (see FIG. 1), at a predetermined angle. In an exemplary embodiment, an angle θ between the reference line L and the reference plane A ranges from approximately 40° to 50°. The illustrated embodiment has an angle of approximately 45°.

By installing the second lens unit 40 above the first lens unit 30 so that there is about a 45° angle between the reference line L and the reference plane A, the total width in a parallel direction of the reference plane A can be reduced. In other words, the image photographing apparatus can be manufactured in a smaller size. By the nature of the apparatus, the main body 10 tends to be cube-shaped. If the first and second lens units 30, 40 are arranged to at the corners of the main body 10 as in the exemplary embodiments of the invention, both the horizontal and vertical sizes of the main body 10 can be minimized while using the interior space of the main body 10 more efficiently.

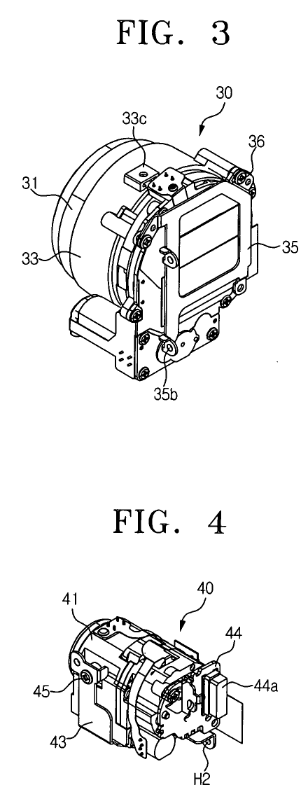

A method of assembling the image photographing apparatus according to an exemplary embodiment of the present invention will now be described. Initially, one of the first and second lens units 30, 40 is assembled. If the first lens unit 30 is assembled first, the lens holder 33 is inserted into the first lens module 31. Then, the lens holder 33, the first lens module 31, and the first support bracket 35 (here, the first support bracket 35 is placed behind the first lens module 31) are combined with the screws 36. In this manner, the assembly of the first lens unit 30 is finished as depicted in FIG. 3. Of course, before assembling the first support bracket 35, the coupling part 31b and the CCD (not shown) are assembled behind the first lens module 31.

Next, the second lens unit 40, the CCD 42 and the CCD board 44 are sequentially assembled to the second lens module 41. Then, the second support bracket 43 is linked to the second lens module 41 using the screw 45. In this manner, the assembly of the second lens unit 40 is finished as shown in FIG. 4.

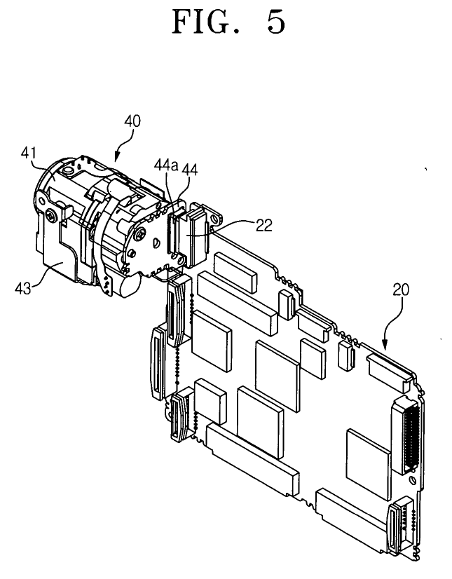

The completely assembled second lens unit 40 is joined with the board 20 by the screw 46. That is, the screw 46 is inserted into the second locking hole H2 of the second support bracket 43 to fasten the second lens unit 40 to the board 20. The connector 44a of the CCD board 44 is joined with the connecter 22 of the board 20. In this manner, the assembly of the second lens unit 40 to the board 20 is finished as illustrated in FIG. 5.

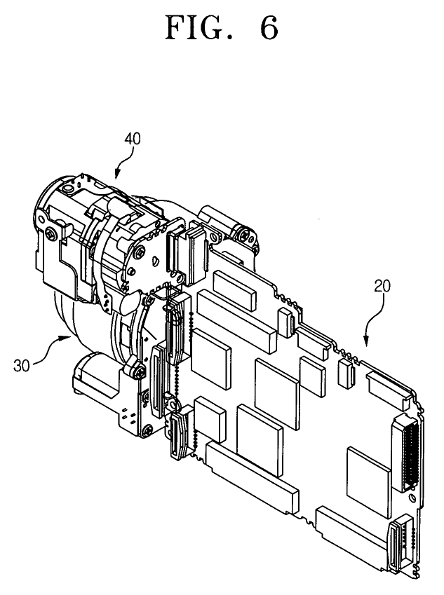

The completely assembled first lens unit 30 is then joined with the board 20. In detail, the screw 37 is inserted into the second screw hole 35b of the first support bracket 35 to fasten the first lens unit 30 to the board 20. In this manner, the assembly of the first lens unit 30 to the board 20 is finished as illustrated in FIG. 6.

In this state, the second support bracket 43 is joined with the lens holder 33 using the screw 48 to complete the assembly work of the dual-lens assembly 100.

Finally, the board 40 and the lens units 30, 40 are connected through a signal cable, so that signals and power can be transferred to each other.

According to the exemplary embodiment of the dual-lens assembly and the image photographing apparatus of the present invention, the overall size of the set and the interior space of the apparatus can be reduced by arranging two lens units in an oblique direction crossing the reference plane of the board at an angle.

Moreover, since the first and second lens units are all assembled to one board, the total number of components used can be reduced and the assembly time can be shortened. Accordingly, manufacturing productivity is enhanced and manufacturing costs can be reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A dual-lens assembly, comprising:
a board for performing a predetermined function in an image photographing apparatus;
a first lens unit joined with the board, the first lens unit having a first optical axis; and
a second lens unit joined with the board, the second lens unit having a second optical axis, the second lens unit being oriented to obtain an image in the same direction as the first lens unit.

2. The dual-lens assembly according to claim 1, wherein
the first and second lens units are arranged so that a virtual reference line connecting the first and second optical axes crosses a plane of the board.

3. The dual-lens assembly according to claim 2, wherein
an angle between the reference line and the plane of the board ranges from 40° to 50°.

4. The dual-lens assembly according to claim 1, wherein the first lens unit comprises:
a first lens module for photographing high quality picture images;
a lens holder for encompassing the first lens module; and
a first support bracket attached to the board for supporting the lens holder and the first lens module.

5. The dual-lens assembly according to claim 4, wherein the second lens unit comprises:
a second lens module for obtaining moving picture quality images; and
a second support bracket for supporting the second lens module to the board and the first lens unit.

6. The dual-lens assembly according to claim 5, wherein
the second support bracket comprises a first locking hole through which a screw is inserted into the second lens module, a second locking hole through which a screw is inserted into the lens holder, and a third locking hole through which a screw is inserted into the board.

7. The dual-lens assembly according to claim 1, wherein
the first lens unit is installed at a lower position than the second lens unit.

8. The dual-lens assembly according to claim 1, wherein
the optical axis of the first lens unit is separated from the plane of the board.

9. The dual-lens assembly according to claim 8, wherein
the optical axes of the first and second lens units are separated.

10. The dual-lens assembly according to claim 1, wherein
the first and second lens units are installed on opposite sides of the board and are vertically offset with respect to one another.

11. An image photographing apparatus, comprising:
a main body;
a board for performing a predetermined function disposed in the main body;
a first lens unit joined with the board, the first lens unit having a first optical axis; and
a second lens unit joined with the board, the second lens unit having a second optical axis, the second lens unit being oriented to obtain an image in the same direction as the first lens unit.

12. The apparatus according to claim 11, wherein
the first and second lens units are arranged so that a virtual reference line connecting the first and second optical axes crosses a plane of the board.

13. The apparatus according to claim 12, wherein
an angle between the reference line and the plane of the board ranges from 40° to 50°.

14. The apparatus according to claim 11, wherein the first lens unit comprises:
a first lens module for photographing high quality picture images;
a lens holder for encompassing the first lens module; and
a first support bracket attached to the board for supporting the lens holder and the first lens module.

15. The apparatus according to claim 14, wherein the second lens unit comprises:
a second lens module for obtaining moving picture quality images; and
a second support bracket for supporting the second lens module to the board and the first lens unit.

16. The apparatus according to claim 15, wherein
the second support bracket comprises a first locking hole through which a screw is inserted into the second lens module, a second locking hole through which a screw is inserted into the lens holder, and a third locking hole through which a screw is inserted into the board.

17. An image photographing apparatus, comprising:
a main body;
a board disposed in the main body, the board having a plurality of electronic components for processing image data;
a first lens unit mounted on the board and having a first optical axis, the first lens unit obtaining image data of a first quality and providing the image data to the plurality of electronic components; and
a second lens unit mounted on the board and having a second optical axis, the second lens unit obtaining image data of a second quality and providing the image data to the plurality of electronic components,
wherein the first and second optical axes are generally aligned so that the first and second lens units obtain images from the same direction.

18. The apparatus of claim 17, wherein
the board is substantially planar and is vertically aligned in the main body, and the first and second lens units are mounted on opposite sides of the board.

19. The apparatus of claim 18, wherein
a line extending between the first and second axes forms an angle of about 40° to 50° with respect to the board.

20. The apparatus of claim 19, wherein
the first quality of obtained image data is higher than the second quality of obtained image data.
